(19) United States
(12) Patent Application Publication
(10) Pub. No.: US 2015/0331278 A1
(43) Pub. Date: Nov. 19, 2015

(54) DISPLAY DEVICE

(71) Applicant: Japan Display Inc., Tokyo (JP)

(72) Inventors: Shigesumi ARAKI, Tokyo (JP); Kazuhiro NISHIYAMA, Tokyo (JP)

(21) Appl. No.: 14/708,946

(22) Filed: May 11, 2015

(30) Foreign Application Priority Data
May 14, 2014 (JP) 2014-100498

(51) Int. Cl. G02F 1/1335; G02F 1/1362

(52) U.S. Cl. CPC G02F 1/133514; G02F 1/1362; G02F 1/133617; G02F 1/133528; G02F 2001/136222

(57) ABSTRACT

Phosphors or quantum dots cannot convert all the excitation lights, but the remaining excitation lights have to be absorbed with a color filter without passing through. A display device includes an array substrate having a color layer and an opposite substrate. The color layer includes a red fluorescence layer for converting blue light into red, a green fluorescence layer for converting blue light into green, and a blue fluorescence layer for compensating blue light. Both of the red fluorescence layer and the green fluorescence layer include the phosphors or quantum dots with two types of dominant wavelengths. The blue fluorescence layer includes the phosphors or quantum dots with one type of dominant wavelength.

### CLAIM OF PRIORITY

The present application claims priority from Japanese patent application JP2014-100498 filed on May 14, 2014, the content of which is hereby incorporated by reference into this application.

### BACKGROUND

This disclosure relates to a display device and can be applied to a display device, for example, using phosphors or quantum dots for color layers.

In a general liquid crystal display device, color display is performed on a screen by using a combination of a white light source and a color filter. This color filter is to perform a color display by selecting the wavelength of a light of the white light source and absorbing a part of the above and therefore, low in transmittance and utilization efficiency of light source light.

As disclosed in Japanese Patent Publication Laid-Open No. 2003-255320, phosphors which emit lights of the same color as the color filter are dispersed in the color filter and excited by ultraviolet ray or blue light emitted from a fluorescence tube, thereby emitting color with an improved efficiency of light utilization.

### SUMMARY

Phosphors or quantum dots cannot convert all the excitation lights but the remaining excitation lights have to be absorbed by a color filter without passing through.

Other problems and new features will be apparent from the description of the disclosure and the accompanying drawings.

The following is a brief description of the gist of the representative elements of the disclosure.

In short, a display device includes an array substrate having a color layer, an opposite substrate, and a liquid crystal layer interposed between the array substrate and the opposite substrate. The color layer includes a red fluorescence layer for converting blue light into red, a green fluorescence layer for converting blue light into green, and a blue fluorescence layer for compensating blue light. Both of the red fluorescence layer and the green fluorescence layer include the phosphors or quantum dots with two types of dominant wavelengths. The blue fluorescence layer includes the phosphors or quantum dots with one type of dominant wavelength.

### BRIEF DESCRIPTION OF THE DRAWINGS

FIG. 1 is a cross sectional view illustrating the structure of a display device according to a comparison example.

FIG. 2 is a cross sectional view illustrating the structure of a color layer according to the comparison example.

FIG. 3 is a cross sectional view illustrating the structure of a liquid crystal display device according to an embodiment.

FIG. 4 is a cross sectional view illustrating the structure of a color layer according to the embodiment.

FIG. 5 is a view illustrating a blue fluorescence distribution of the AdobeRGB standard.

FIG. 6 is a blue XY chromaticity diagram of the AdobeRGB standard.

FIG. 7 is a view illustrating a green fluorescence distribution of the AdobeRGB standard.

FIG. 8 is a green XY chromaticity diagram of the AdobeRGB standard.

FIG. 9 is a view illustrating a red fluorescence distribution of the AdobeRGB standard.

FIG. 10 is a red XY chromaticity diagram of the AdobeRGB standard.

FIG. 11 is a view illustrating a green fluorescence distribution of the sRGB standard.

FIG. 12 is a green XY chromaticity diagram of the sRGB standard.

FIG. 13 is a top plan view for use in describing the structure of a display device according to the first example.

FIG. 14 is a cross sectional view of a TFT contact hole portion for use in describing the structure of the display device according to the first example.

FIG. 15 is a cross sectional view of a pixel center portion for use in describing the structure of the display device according to the first example.

FIG. 16 is a cross sectional view of the TFT contact hole portion for use in describing the structure of a display device according to a second example.

FIG. 17 is a cross sectional view of the pixel center portion for use in describing the structure of the display device according to the second example.

### DESCRIPTION OF THE PREFERRED EMBODIMENTS

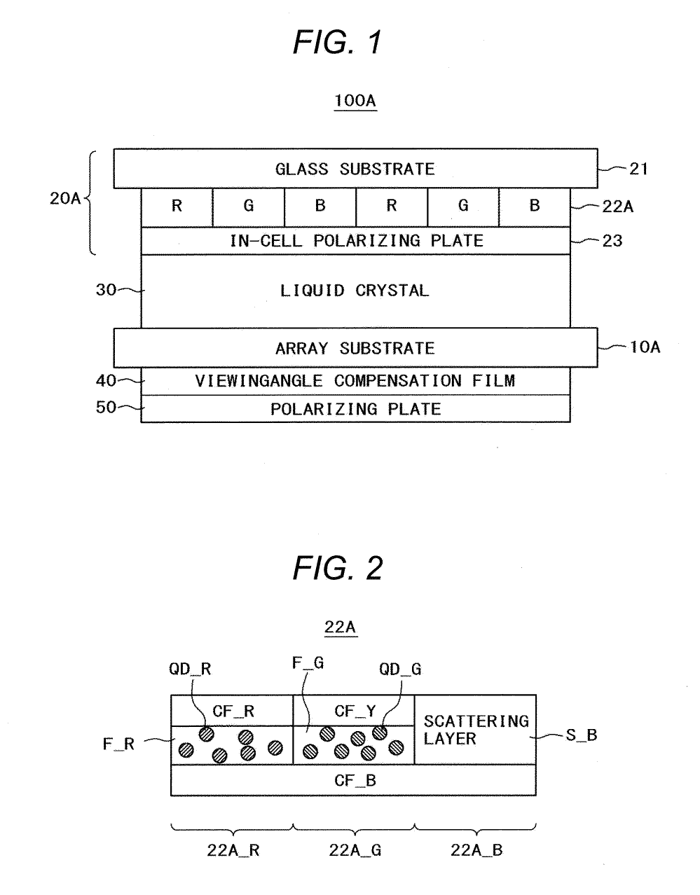

At first, a display device (hereinafter, referred to as a comparison example) examined prior to this disclosure, in which the quantum dots are used for a color layer, will be described using FIGS. 1 and 2.

FIG. 1 is a cross sectional view for use in describing the structure of the display device according to the comparison example. FIG. 2 is a cross sectional view for use in describing the structure of a color layer according to the comparison example.

A display device 100A according to the comparison example includes an array substrate 10A and an opposite substrate 20A. The display device 100A includes a liquid crystal layer 30 between the array substrate 10A and the opposite substrate 20A. A viewing angle compensation film 40 and a polarizing plate 50 are provided on the array substrate 10A at a side opposite to the liquid crystal layer 30. TFTs (Thin Film Transistors) and pixel electrodes are arranged on the array substrate 10A at a side of the glass substrate and the liquid crystal layer 30. The opposite substrate 20A includes a glass substrate 21, a color layer 22A, and an in-cell polarizing plate 23. Light source light (excitation light) enters from the side of the polarizing plate 50 and a user observes the light from the side of the opposite substrate 20A.

The color layer 22A includes a red color layer 22A R, a green color layer 22A_G, and a blue color layer 22_AB. The red color layer 22A_R is formed by a blue color filter CF_B, a red fluorescence layer F_R, and a red color filter CF_R. The green color layer 22A_G is formed by a blue color filter CF_B, a green fluorescence layer F_G, and a yellow color filter CF_Y. The blue color layer 22A B is formed by a blue color filter CF_B and a blue scattering layer S_B for scattering the blue light source light. The red fluorescence layer F_R includes red quantum dots QD_R for converting the blue light source light into red. The Dominant wavelength of the red quantum dots QD_R included in the red fluorescence layer F_R is one. The green fluorescence layer F_G includes green quantum dots QD_G for converting the blue light source light into green. The dominant wavelength of the green quantum dots QD_G included in the green fluorescence layer F_G is one. In FIG. 2, the red fluorescence layer F_R, the green fluorescence layer F_G, and the blue scattering layer S_B are seemed to be in contact with each other; however, light shielding layers are respectively arranged between the adjacent layers of the red fluorescence layer F_R, the green fluorescence layer F_G, and the blue scattering layer S_B in order to avoid color mixture.

Phosphors or quantum dots cannot convert all the excitation lights but the remaining excitation lights have to be absorbed without being transmitted.

When a light having the same wavelength region as the blue used for the excitation light of the red quantum dot QD_R and the green quantum dot QD_G enters externally into the same dots, the red quantum dot QD_R and the green quantum dot QD_G can absorb the above and emit light. This fluorescence is not controlled by the array substrate 10 but becomes an unnecessary light; when the above light is observed by a user, there occurs a reduction in contrast ratio and color purity in a display, which causes deterioration of outdoor visibility.

Accordingly, in the display device 100A of the comparison example, a red color filter CF_R is arranged in front of the red fluorescence layer F_R and a yellow color filter CF_Y is arranged in front of the green fluorescence layer F_G.

The red color filter CF_R and the yellow color filter CF_Y absorb the blue light and pass the red light and the green light respectively. The above filters restrain the blue lights from coming to the red quantum dot QD_R and the green quantum dot QD_G from the outside and suppress the remaining blue excitation lights going outward, and at the same time, pass the red and the green fluorescence going outward at a high transmittance. According to this, the red quantum dot QD_R and the green quantum dot QD_G do not emit fluorescence by the external light excitation and the remaining excitation lights are not transmitted, thereby improving the visibility.

In order to reduce the unnecessary light component, there is provided with the blue color filter CF_B between the red fluorescence layer F_R, green fluorescence layer F_G, and blue scattering layer S_B and the in-cell polarizing plate 23. The blue color filter CF_B passes the light source light but absorbs the fluorescence of the red quantum dot QD_R and the green quantum dot QD_G. Therefore, it is possible to inhibit the image quality reduction at least caused by the fluorescence of the red quantum dot QD_R and the green quantum dot QD_G.

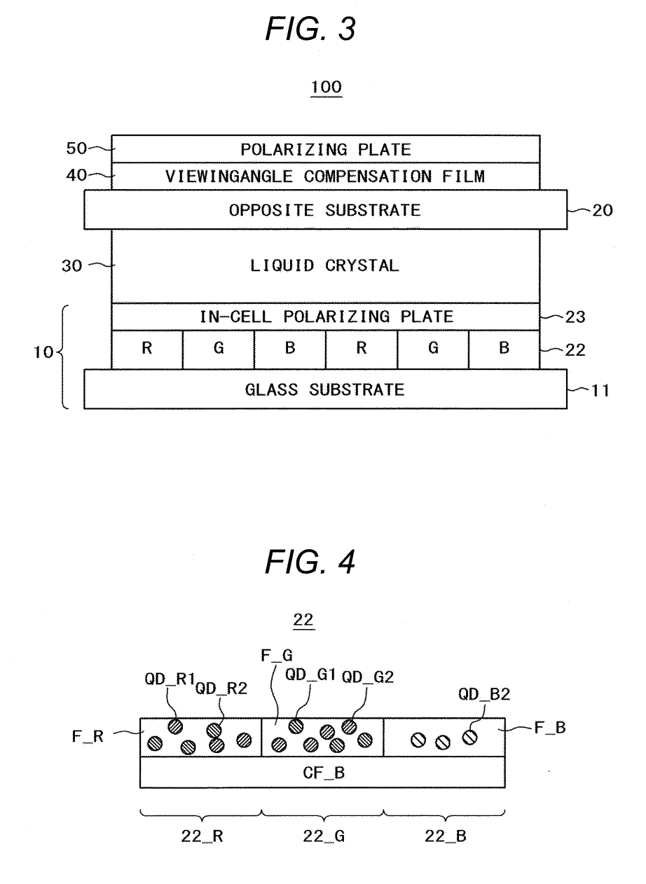

Next, a display device according to the embodiment will be described using FIGS. 3 and 4.

FIG. 3 is a cross sectional view for use in describing the structure of a liquid crystal display device according to the embodiment. FIG. 4 is a cross sectional view for use in describing the structure of a color layer according to the embodiment.

A display device 100 according to the embodiment includes an array substrate 10 and an opposite substrate 20. The display device further includes a liquid crystal layer 30 between the array substrate 10 and the opposite substrate 20. The array substrate 10 includes a glass substrate 11 with TFTs formed, a color layer 22, and an in-cell polarizing plate 23. The opposite substrate 20 includes a glass substrate. A viewing angle compensation film 40 and a polarizing plate 50 are provided on the opposite substrate 20 at a side opposite to the liquid crystal layer 30. Light source light (excitation light) enters from the side of the glass substrate 11 and a user observes the light at the side of the polarizing plate 50.

The color layer 22 includes a red color layer 22_R, a green color layer 22_G, and a blue color layer 22_B. The red color layer 22_R includes a blue color filter CF B and a red fluorescence layer F_R for converting blue light source light into red. The green color layer 22_G includes the blue color filter CF_B and a green fluorescence layer F_G for converting the blue light source light into green. The blue color layer 22_B includes the blue color filter CF_B and a blue fluorescence layer F_B for compensating the blue light source light. The red fluorescence layer F_R includes a red quantum dot QD_R1 and a red compensation quantum dot QD_R2, the green fluorescence layer F_G includes a green quantum dot QD_G1 and a green compensation quantum dot QD_G2, and the blue fluorescence layer F_B includes a blue compensation quantum dot QD_B2. The red quantum dot QD_R1 and the red compensation quantum dot QD_R2 are different in the dominant wavelength. The green quantum dot QD_G1 and the green compensation quantum dot QD_G2 are different in the dominant wavelength. The dominant wavelength of the blue compensation quantum dot QD_B2 is different from the wavelength of the blue light source light. The amount of the blue compensation quantum dot QD_B2 is less than the total amount of the red quantum dot QDR1 and the red compensation quantum dot QD_R2 and less than the total amount of the green quantum dot QDG1 and the green compensation quantum dot QD_G2. In FIG. 4, the red fluorescence layer F_R, the green fluorescence layer F_G, and the blue fluorescence layer F_B are seemed to be in contact with each other; however, in order to prevent color mixture, light shielding layers are preferably arranged between the red fluorescence layer F_R, the green fluorescence layer F_G, and the blue fluorescence layer F_B.

As mentioned above, the quantum dots cannot convert all the excitation lights, but the remaining excitation lights have to be absorbed without passing through, which is performed by using the color filter according to the display device of the comparison example. On the other hand, in the display device according to the embodiment, the remaining excitation lights are designed not to be absorbed but to be transmitted, color compensation is performed using the quantum dots, and as the result, there is no need to use a color filter.

As mentioned above, when the light having the same wavelength region as the blue used for the excitation light of the quantum dot enters from the outside, the quantum dot may absorb the above light and emit luminescence. In the display device 100A of the comparison example, the red color filter CF_R is arranged in front of the red fluorescence layer F_R and the yellow color filter CF_Y is arranged in front of the green fluorescence layer F_G. On the other hand, in the display device according to the embodiment, the color layer 22 is arranged under the liquid crystal layer 30 and the in-cell polarizing plate 23, so as not to be affected by the outside light, with no need of a color filter.

Accordingly, in the display device according to the embodiment, a color filter of absorbing the blue light is not used for the red color layer 22_R and the green color layer 22_G.

In order to reduce the unnecessary light component, similarly to the display device 100A of the comparison example, it is preferable to arrange the blue color filter CF_B between the red fluorescence layer F_R, green fluorescence layer F_G, and blue fluorescence layer F_B and the array substrate 10. The blue color filter CF_B passes the light source light but absorbs the fluorescence of the red fluorescence layer F_R and the green fluorescence layer F_G. Therefore, it is possible to inhibit the image quality reduction caused by at least the fluorescence of the red fluorescence layer F_R and the green fluorescence layer F_G. Instead of the blue color filter CF_B, a layer reflecting a light other than blue may be used.

Generally, the liquid crystal display device makes a display in such a way that a linearly polarized light entering from the polarizing plate is controlled according to the orientation of liquid crystal molecules and that only the polarized light in accord with the direction of the transmittance axis of the opposed polarizing plate (polarizing plate at a light emitting side) is transmitted. A light emitted from the phosphor is a scattering light to be scattered to all the directions; therefore, when the fluorescence layer is arranged in a space where the linearly polarized lights are controlled, in other words, between the two polarizing plates, the controlled polarization lights are disturbed, affecting the display largely. Accordingly, the color layer 22 formed by the fluorescence layer is arranged at the outer side of the in-cell polarizing plate 23 from the liquid crystal layer 30.

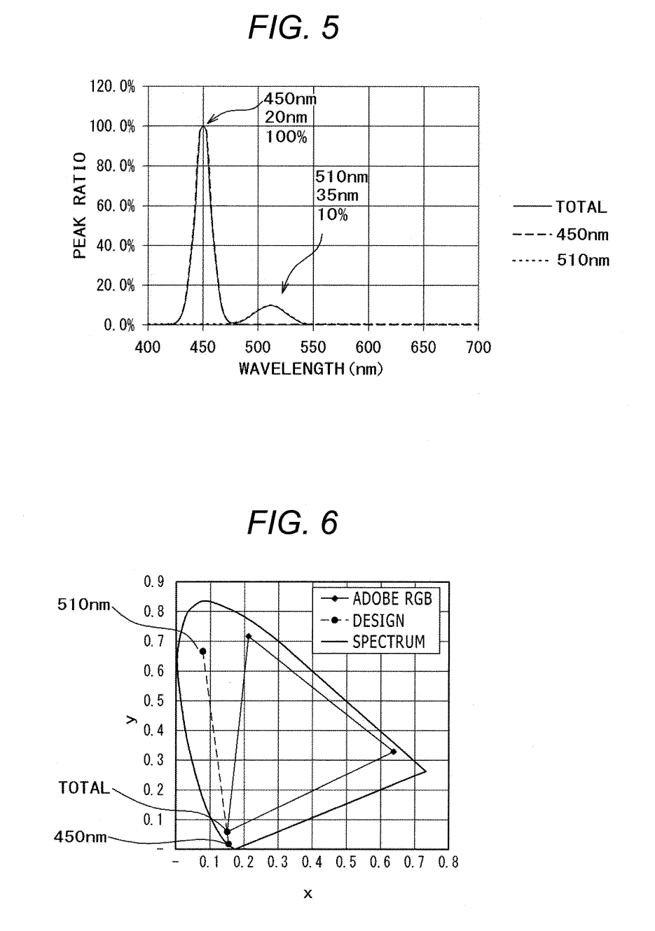

The color layer 22 (the red fluorescence layer F_R, the green fluorescence layer F_G, and the blue fluorescence layer F_B) will be described using FIGS. 5 to 12.

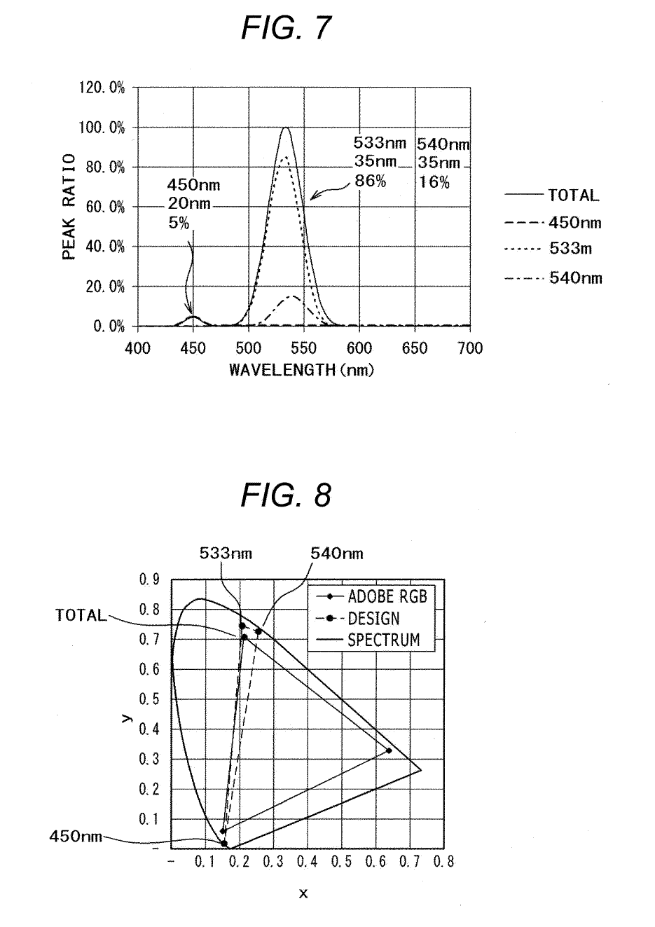

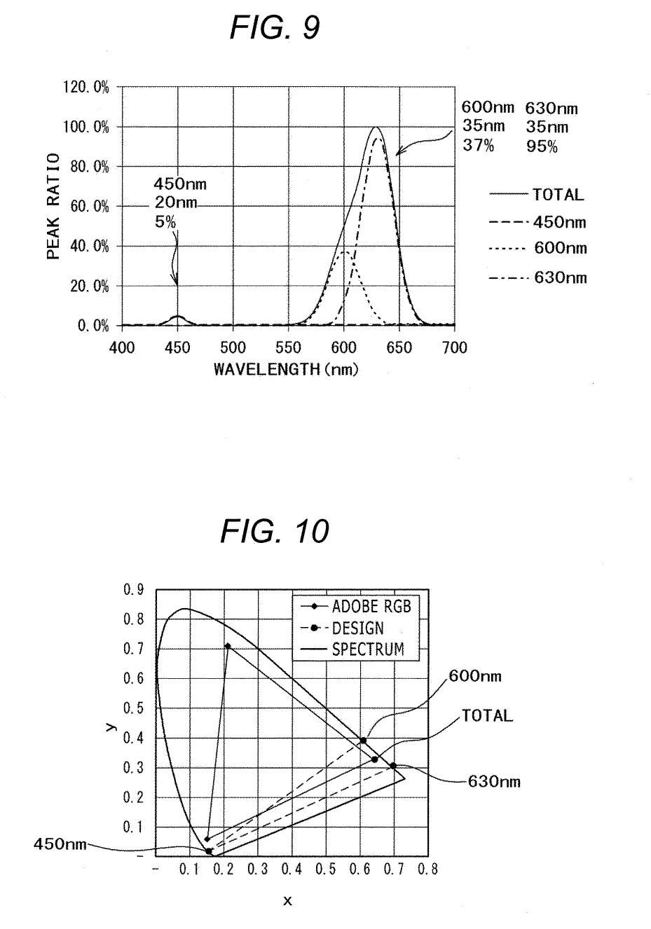

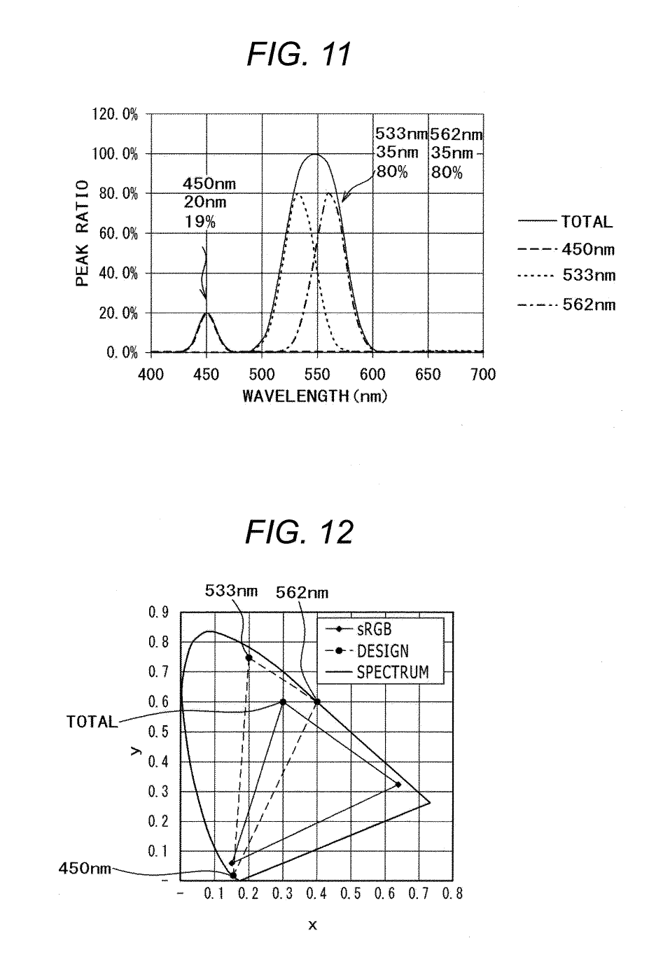

FIG. 5 is a view illustrating a fluorescence distribution for satisfying the blue of the AdobeRGB standard. FIG. 6 is as XY chromaticity diagram for satisfying the blue of the AdobeRGB standard. FIG. 7 is a view illustrating a fluorescence distribution for satisfying the green of the AdobeRGB standard. FIG. 8 is an XY chromaticity diagram for satisfying the green of the AdobeRGB standard. FIG. 9 is a view illustrating a fluorescence distribution for satisfying the red of the AdobeRGB standard. FIG. 10 is an XY chromaticity diagram for satisfying the red of the AdobeRGB standard. FIG. 11 is a view illustrating a fluorescence distribution for satisfying the green of the sRGB standard. FIG. 12 is an XY chromaticity diagram for satisfying the green of the sRGB standard.

The red fluorescence layer F_R, the green fluorescence layer F_G, and the blue fluorescence layer F_B are transparent resin where the quantum dots, absorbing the wavelength region of the blue light source light (excitation light) and emitting the fluorescence of each color, are dispersed. As mentioned above, the quantum dots cannot convert all the excitation lights but the remaining excitation lights are transmitted. Because there remain the excitation lights (blue lights), color compensation is performed.

As illustrated in FIG. 5, in order to create the blue of the AdobeRGB standard, the blue fluorescence layer F_B is designed to include a blue compensation quantum dot QD_R′ so that the dominant wavelength may be 510 nm, the half width may be 35 nm, and that the peak ratio may be 10%. The dominant wavelength of the blue light (light source light) passing through the blue fluorescence layer F_B is 450 nm and the half width is 20 nm. As illustrated in FIG. 6, when using the blue light (light source light) having the dominant wavelength of 450 nm, the blue becomes too strong compared to the blue of the AdobeRGB standard, and therefore, by including the blue compensation quantum dot QD_R′ having the dominant wavelength of 510 nm with a suggestion of green, the light can be the blue of the AdobeRGB standard. Here, the blue of the sRGB standard and the blue of the AdobeRGB standard are identical.

As illustrated in FIG. 7, in order to create the green of the AdobeRGB standard, the green fluorescence layer F_G is designed to include the green quantum dot QD_G so that the dominant wavelength may be 533 nm, the half width may be 35 nm, and that the peak ratio may be 86% and a green compensation quantum dot QD_G′ so that the dominant wavelength may be 540 nm, the half width may be 35 nm, and that the peak ratio may be 16%. As for the blue light (light source light) passing through the green fluorescence layer F_G, the dominant wavelength thereof is 450 nm, the half width is 20 nm, and the peak ratio is 5%. As illustrated in FIG. 8, by including the blue light (light source light) having the dominant wavelength of 450 nm, the green fluorescence layer F_G having the dominant wavelength of 533 nm, and the green compensation quantum dot QD_G′ having the dominant wavelength of 540 nm, the light can be the green of the AdobeRGB standard. Here, the green of the sRGB standard is different from the green of the AdobeRGB standard.

As illustrated in FIG. 9, in order to create the red of the AdobeRGB standard, the red fluorescence layer F_R is designed to include the red quantum dot QD_R so that the dominant wavelength may be 630 nm, the half width may be 35 nm, and that the peak ratio may be 95% and a red compensation quantum dot QD_R′ so that the dominant wavelength may be 600 nm, the half width may be 35 nm, and that the peak ratio may be 37%. As for the blue light (light source light) passing through the red fluorescence layer F_R, the dominant wavelength thereof is 450 nm, the half width is 20 nm, and the peak ratio is 5%. As illustrated in FIG. 10, by including the blue light (light source light) having the dominant wavelength of 450 nm, the red fluorescence layer F_R having the dominant wavelength of 630 nm, and the green compensation quantum dot QD_R′ having the dominant wavelength of 600 nm, the light can be the red of the AdobeRGB standard. Here, the red of the sRGB standard and the red of the AdobeRGB standard are identical.

As illustrated in FIG. 11, in order to create the green of the sRGB standard, the green fluorescence layer F_G is designed to include the green quantum dot QD_G so that the dominant wavelength may be 562 nm, the half width may be 35 nm, and that the peak ratio may be 80% and the green compensation quantum dot QD_G′ so that the dominant wavelength may be 533 nm, the half width may be 35 nm, and that the peak ratio may be 80%. As for the blue light (light source light) passing through the green fluorescence layer F_G, the dominant wavelength thereof is 450 nm, the half width is 20 nm, and the peak ratio is 19%. As illustrated in FIG. 12, by including the blue light (light source light) having the dominant wavelength of 450 nm, the green fluorescence layer F_G having the dominant wavelength of 562 nm, and the green compensation quantum dot QD_G′ having the dominant wavelength of 533 nm, the light can be the green of the sRGB standard.

The light source light and the quantum dot, and the dominant wavelength and the peak ratio of the compensation quantum dot mentioned above are only one example and not restricted to the above example. By combination of a plurality of dominant wavelengths, each color can be created to satisfy the AdobeRGB standard and the sRGB standard.

In the above description, quantum dots are used in a fluorescence layer; however, instead of the quantum dot, phosphor may be used.

In a display device using phosphors or quantum dots for a color layer, second phosphors or quantum dots for color compensation are added to each color layer.

In other words, the red color layer and the green color layer include mixture of phosphors or quantum dots having two types of dominant wavelengths and use the transmitted light of the light source. The blue color layer includes one type of phosphors or quantum dots. As a combination of the phosphors or the quantum dots having two types of the dominant wavelengths, a hybrid structure including the phosphor and the quantum dot may be used for the color layer.

The light source transmitted light can be used without absorbing. By mixing at least two and more phosphors or quantum dots to adjust the color, the mixture ratio of the blue light (450 nm) can be increased. Since the two and more phosphors or quantum dots are mixed, a fluorescence distribution asymmetrical with respect to the peak wavelength can be obtained.

The liquid crystal display mode for carrying out the embodiment is not restricted to the above example but it may be the TN (Twisted Nematic) method of switching liquid crystal molecules using the electric field substantially vertical to the substrate surface, the VA (Vertical Alignment) method, the IPS (In Plane Switching) method of switching liquid crystal molecules using the electric field substantially parallel to the substrate surface, or the FFS (Fringe Field Switching) method in which an electrode for driving liquid crystals is superimposed within pixel and the liquid crystal molecules are switched by the fringe electric field in the vicinity of the electrode. Further, the display device for carrying out the embodiment is not restricted to a liquid crystal display device but can be applied to an organic EL display device using a color filter.

### FIRST EXAMPLE

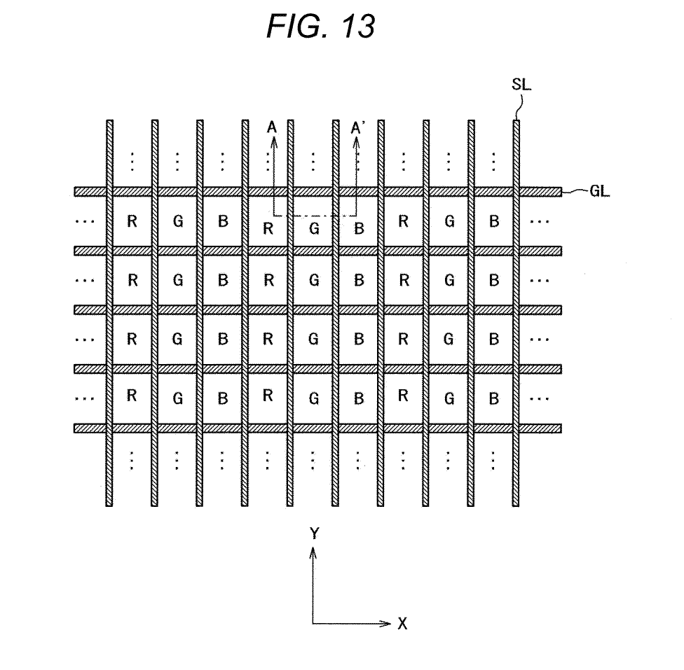

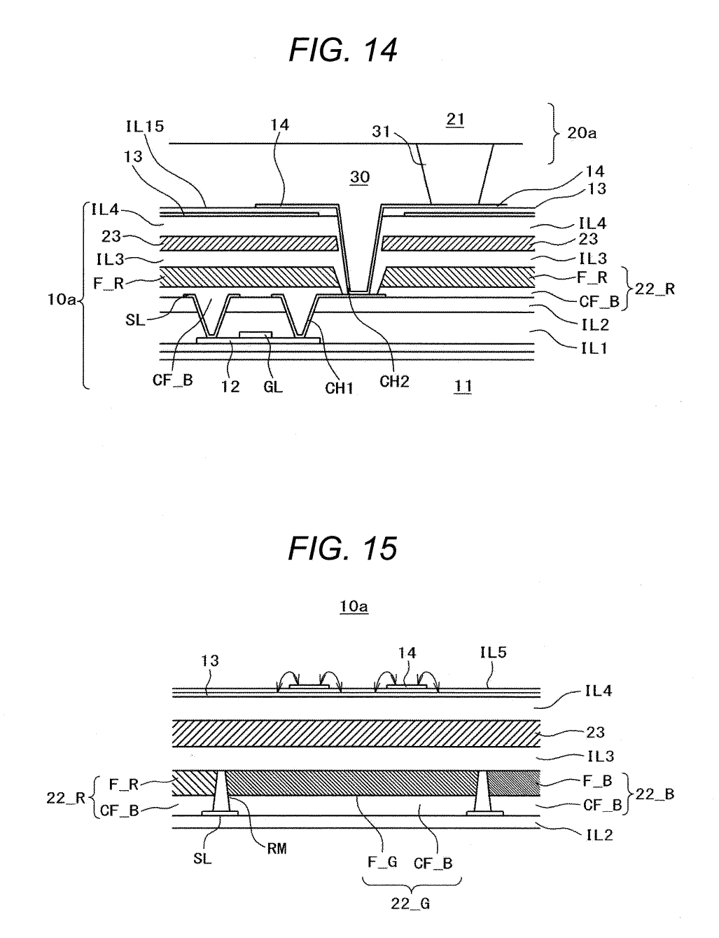

A first example will be described using FIGS. 13 and 14.

FIG. 13 is a top plan view for use in describing the structure of a display device according to the first example. FIG. 14 is a cross sectional view of the TFT contact hole portion for use in describing the display device according to the first example. FIG. 15 is a cross sectional view of a pixel center portion for use in describing the display device according to the first example. FIG. 15 is a cross sectional view taken along the line A-A′ of FIG. 13.

The display device according to the first example includes vertical stripe-shaped sub-pixels of red (R), green (G), and blue (B) and the RGB is arranged as one pixel. A color layer 22 may be formed in such a way that R, G, and B are arranged repeatedly in this order in the column direction (X direction) and that the same color is arranged in the row direction (Y direction) of the color layer 22. A gate line GL extends in the X direction and a source line SL extends in the Y direction.

The array substrate 10a includes a thin film transistor 12, a signal wiring SL, a scanning wiring GL, the color layer 22, the in-cell polarizing plate 23, a common electrode 13, a pixel electrode 14, on a first glass substrate 11. The color layer 22 including the blue color filter CF_B and the fluorescence layers F_R, F_G, and F_B is provided on the signal wiring SL and an insulating film IL2. The fluorescence layers F_R, F_G, and F_B are the same as those having been respectively described. Reflection metals (light shielding layers) RM are provided respectively between the red color layer 22_R, the green color layer 22_G, and the blue color layer 22_B. The in-cell polarizing plate 23 is provided on the color layer 22 through an insulating film IL3. The common electrode 13 is provided on the in-cell polarizing plate 23 through an insulating film IL4. The pixel electrode 14 is provided on the common electrode 13 through an insulating film IL5. The common electrode 13 and the pixel electrode 14 are formed of ITO (Indium Tin Oxide) superior in transparency and conductivity. The signal wiring SL and the scanning wiring GL cross each other and the thin film transistor 12 is provided in the vicinity of the intersection in one-to-one correspondence with the pixel electrode 14. A potential corresponding to the image signal is applied to the pixel electrode 14 from the signal wiring SL through the thin film transistor 12 and contact holes CH1 and CH2 and the operation of the thin film transistor 12 is controlled according to a scanning signal of the scanning wiring GL. A channel portion of the thin film transistor 12 is formed of an amorphous silicon layer and other than this, the channel portion may be formed of a polysilicon layer having a higher mobility. A first alignment film, not illustrated, is provided on the pixel electrode 14 at a side near the liquid crystal layer 30. The first alignment film is an organic polymer membrane of polyimide, which is aligned in a predetermined direction.

The opposite substrate 20a includes a schematically cylindrical post spacer (column spacer) 31 provided on the second glass substrate 21 at a side near the liquid crystal layer 30 and a second alignment film not illustrated. The second alignment film is an organic polymer membrane of polyimide, which is aligned in a predetermined direction, similarly to the first alignment film.

The array substrate 10a with the color layer 22 and the in-cell polarizing plate 23 arranged and the opposite substrate 20a are assembled together and the space therebetween is evenly kept by the column spacer 31 arranged on the side of the opposite substrate 20a. A liquid crystal material is injected into the space.

On the top surface of the opposite substrate 20a (observer side), the viewing angle compensation film 40 and the polarizing plate 50 as illustrated in FIG. 3 are arranged. The in-cell polarizing plate 23 and the polarizing plate 50 are arranged in such a way that the absorption axes may mutually cross each other at a right angle when being observed in the front normal direction and that the absorption axis of the polarizing plate 50 may be in parallel to the liquid crystal alignment direction of the second alignment film. A backlight (illumination device) having a blue light source, not illustrated, is provided on the lower side of the array substrate 10a (on the side opposite to the observer). The blue light source is a blue light emitting diode, showing a bright line-shaped emission spectrum with the wavelength of 450 nm as the dominant and with the half width of about 20 nm.

### SECOND EXAMPLE

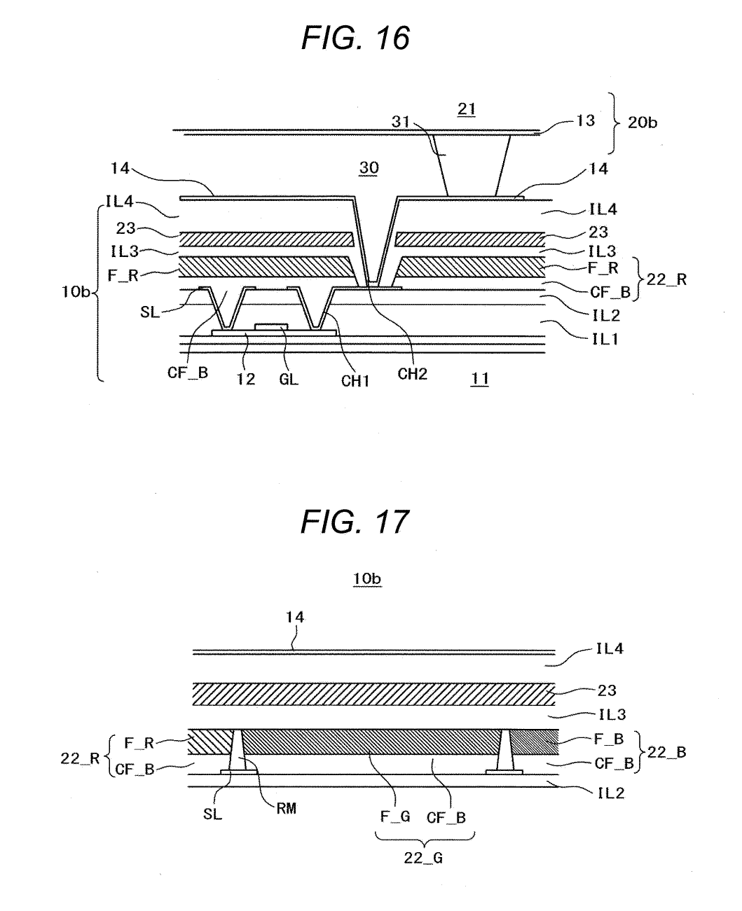

A second example will be described using FIGS. 16 and 17.

FIG. 16 is a cross sectional view of the TFT contact hole portion for use in describing the display device according to the second example. FIG. 17 is across sectional view of the pixel center portion for use in describing the display device according to the second example.

The display device according to the second example is the same as the display device according to the first example, except that the common electrode 13 is formed on the opposite substrate 20a and that according to this, the insulating film IL5 is removed.

Specifically, the array substrate 10b includes the thin film transistor 12, the signal wiring SL, the scanning wiring GL, the color layer 22, the in-cell polarizing plate 23, and the pixel electrode 14 on the first glass substrate 11. The pixel electrode 14 is formed on the in-cell polarizing plate 23 through the insulating film IL4.

The opposite substrate 20b includes the common electrode 13, the schematically cylindrical post spacer (column spacer) 31, and the second alignment film not illustrated, provided on the second glass substrate 21 at a side near the liquid crystal layer 30.

What is claimed is:

1. A display device comprising:
an array substrate including a color layer; and
an opposite substrate, wherein
the color layer includes:
a red fluorescence layer for converting blue light into red;
a green fluorescence layer for converting blue light into green; and
a blue fluorescence layer for compensating blue light,
both of the red fluorescence layer and the green fluorescence layer include phosphors or quantum dots with two types of dominant wavelengths, and
the blue color layer includes phosphors or quantum dots with one type of dominant wavelength.

2. The device according to claim 1, wherein the amount of the phosphors or quantum dots included in the blue fluorescence layer is less than the amount of the phosphors or quantum dots included in the red fluorescence layer and less than the amount of the phosphors or quantum dots included in the green fluorescence layer.

3. The device according to claim 1, further comprising:
a liquid crystal layer interposed between the array substrate and the opposite substrate; and
a light source arranged on the array substrate at a side opposite to the color layer;
wherein the blue light is supplied from the light source.

4. The device according to claim 3, wherein the array substrate includes an in-cell polarizing plate between the liquid crystal layer and the color layer.

5. The device according to claim 1, wherein the color layer further includes a blue color filter at a side opposite to the opposite substrate.

6. The device according to claim 3, further comprising
a polarizing plate on the opposite substrate at a side opposite to the liquid crystal layer.

7. The device according to claim 6, further comprising
a viewing angle compensation film between the polarizing plate and the opposite substrate.

8. The device according to claim 1, wherein the red fluorescence layer, the green fluorescence layer, and the blue fluorescence layer are transparent resin with phosphors or quantum dots dispersed.

9. The device according to claim 1, wherein reflection metals are respectively provided between the red fluorescence layer, the green fluorescence layer, and the blue fluorescence layer.

10. The device according to claim 1, wherein the array substrate includes a pixel electrode and a common electrode.

11. The device according to claim 1,
wherein the array substrate includes a pixel electrode, and the opposite substrate includes a common electrode.

12. The device according to claim 1, wherein the red fluorescence layer includes a phosphor or quantum dot with dominant wavelength of 630 nm, half width of 35 nm, and peak ratio of 95% and a phosphor or quantum dot with the dominant wavelength of 600 nm, the half width of 35 nm, and the peak ratio of 37%.

13. The device according to claim 12, wherein the blue light passing through the red fluorescence layer has the dominant wavelength of 450 nm, the half width of 20 nm, and the peak ratio of 5%.

14. The device according to claim 1, wherein the green fluorescence layer includes a phosphor or quantum dot with the dominant wavelength of 533 nm, the half width of 35 nm, and the peak ratio of 86% and a phosphor or quantum dot with the dominant wavelength of 540 nm, the half width of 35 nm, and the peak ratio of 16%.

15. The device according to claim 14, wherein the blue light passing through the green fluorescence layer has the dominant wavelength of 450 nm, the half width of 20 nm, and the peak ratio of 5%.

16. The device according to claim 1, wherein the green fluorescence layer includes a phosphor or quantum dot with the dominant wavelength of 562 nm, the half width of 35 nm, and the peak ratio of 80% and a phosphor or quantum dot with the dominant wavelength of 533 nm, the half width of 35 nm, and the peak ratio of 80%.

17. The device according to claim 16, wherein the blue light passing through the green fluorescence layer has the dominant wavelength of 450 nm, the half width of 20 nm, and the peak ratio of 19%.

18. The device according to claim 1, wherein the blue fluorescence layer includes a phosphor or quantum dot with the dominant wavelength of 510 nm, the half width of 35 nm, and the peak ratio of 10%.

19. The device according to claim 18, wherein the blue light passing through the blue fluorescence layer has the dominant wavelength of 450 nm, the half width of 20 nm, and the peak ratio of 100%.
